(19) United States
(12) Patent Application Publication
(10) Pub. No.: US 2009/0024570 A1
(43) Pub. Date: Jan. 22, 2009

(54) USER DEFINED QUERY REWRITE MECHANISM

(75) Inventors: Adiel Yoaz, Foster City, CA (US); Sriram Krishnamurthy, San Francisco, CA (US); Qin Yu, Belmont, CA (US)

Correspondence Address: HICKMAN PALERMO TRUONG & BECKER/ORACLE, 2055 GATEWAY PLACE, SUITE 550, SAN JOSE, CA, 95110-1083, US

(73) Assignee: ORACLE INTERNATONAL CORPORATION, REDWOOD SHORES, CA (US)

(21) Appl. No.: 11/781,139

(22) Filed: Jul. 20, 2007

(51) Int. Cl. G06F 17/30

(52) U.S. Cl. 707/2; 707/E17.017

(57) ABSTRACT

A database statement contains a table function. The database statement is compiled by a database statement compiler. The database statement is rewritten by replacing the table function with a replacement database statement.

### FIELD OF THE INVENTION

The present invention relates to database systems, and in particular, to compiling and computing database statements.

### BACKGROUND

To interact with a database server, a database statement is issued to a database server to cause the database server to perform operations on data stored in the database. For the database server to process the commands, the database statements must conform to a database language supported by the database server. One database language supported by many database servers is known as the Structured Database statement Language (SQL). SQL, as the term is used herein, refers to forms that conform to ANSI standards and/or proprietary standards (e.g. SQL supported by Oracle™ database servers).

A database statement that conforms to database language is referred to herein as a query. The term query encompasses database statements that specify and/or declare data manipulation language (“DML”) operations, including, without limitation, select, insert, update, and delete.

SQL queries may contain a table function, which when executed, returns a collection of elements (e.g. objects). Such queries are referred to herein as table function queries. The following query QE illustrates an example of a table function query.

QE = select * from TABLE(Persons_tf(1))

The table function Persons_tf (1) is contained within a TABLE clause. During execution of QE by a database server, the function Persons_tf (1) is computed to return a collection of objects. To compute the TABLE clause, the collection of elements is converted into a set of rows, each row corresponding to an element.

The elements in the collection returned by a table function each have the same attributes or fields. The elements may be rows or tuples or objects of an object type. An object type is a set of attributes and associated routines and functions that operate on the state of the object, e.g. attributes. The routines or functions of the object type are referred to herein as object methods.

Compiling an SQL statement, as the term is used herein, refers to the process of determining and optimizing operations or steps, resources, and/or data structures that are required to evaluate the SQL statement. A compiler that compiles an SQL statement forms an execution plan that specifies steps for computing the SQL statement. An execution plan may comprise a separate set of steps for computing a table function which includes invoking an implementation of the table function to return results of the table function.

The present application describes novel ways of compiling and computing table function statements.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a procedure for rewriting a table function statement according to an embodiment of the present invention.

FIG. 2 depicts a computer system that may be used in an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Table functions can be used to encapsulate the logic of retrieving data and returning the data in a relational format, e.g. returning a collection of elements that are rows or objects. During execution of the table function statement, the table function internally executes another query and returns the results. According to an embodiment, the original query is rewritten by replacing the table function with the query it intends to execute internally. Thus, when a query compiler optimizes the rewritten query, it is able to optimize in a way that cognizant of the entire set of operations needed for both the outer original query in the query and internally executed query that would otherwise be executed by the table function.

### Illustrative Operating Environment

According to an embodiment, table function queries are rewritten by query compilers of database servers. Generally, a server, such as a database server, is a combination of integrated software components and an allocation of computational resources, such as memory, a node, and processes on the node for executing the integrated software components, where the combination of the software and computational resources are dedicated to providing a particular type of function on behalf of clients of the server. A database server governs and facilitates access to a particular database, processing requests by clients to access the database.

A database comprises data and metadata that is stored on a persistent memory mechanism, such as a set of hard disks. Such data and metadata may be stored in a database logically, for example, according to relational and/or object-relational database constructs. Database metadata defines database objects, such as tables, object tables, views, or complex types, such as object types, and, importantly table functions. SQL data definition language (“DDL”) instructions are issued to a database server to create or configure database objects.

Generally, data is stored in a database in one or more data containers, each container contains records, and the data within each record is organized into one or more fields. In relational database systems, the data containers are typically referred to as tables, the records are referred to as rows, and the fields are referred to as columns. In object oriented databases, the data containers are typically referred to as object types or classes, the records are referred to as objects, and the fields are referred to as attributes. Other database architectures may use other terminology. Systems that implement the present invention are not limited to any particular type of data container or database architecture. However, for the purpose of explanation, the examples and the terminology used herein shall be that typically associated with relational or object-relational databases. Thus, the terms “table”, “row” and “column” shall be used herein to refer respectively to the data container, record, and field.

### Query Optimizer and Execution Plans

A query compiler receives a query and generates an internal query representation of the query. Typically, the internal query representation is a set of interlinked data structures that represent various components and structures of a query statement. The internal representation is typically generated in memory for evaluation, manipulation, and transformation by a query compiler.

A query compiler may generate one or more different candidate execution plans for a query, which are evaluated by the query compiler to determine which should be used to compute the query. Execution plan operations include, for example, a table scan, an index scan, hash-join, sort-merge join, nested-loop join, and filter.

A query compiler may optimize a query by transforming the query. In general, transforming a query involves rewriting a query into another query that should produce the same result and that can potentially be executed more efficiently, i.e. one for which a potentially more efficient and less costly execution plan can be generated. The query as transformed is referred to herein as the transformed query. The query is rewritten by manipulating a copy of the query representation to form a transformed query representation representing a transformed query.

### Table Functions as User Defined Functions

According to an embodiment, a table function is a user-defined function that is registered within a database server. Registering the user-defined function enables the database server to recognize and handle the user-defined function, like natively supported functions, when the user-defined function is presented in queries. Natively supported functions are those defined by an SQL standard (e.g. sum, max).

Registering a user-defined function refers to a database system receiving as input the definition of a user-defined function and configuring itself (e.g. generating metadata) to handle the user-defined functions when the functions appear in queries compiled by the database system. The definition includes the name of the function, arguments and return type of the function, implementations (e.g. code, routines, function) to execute and compute the function. The implementation may have to conform to a format, which may depend on the kind of user-defined function being registered. The implementation may include multiple routines and functions. For example, the implementation may include a separate implementation function for initialization, iteration, and termination.

For a table function, the implementation may include a function that returns a replacement query to replace the table function in a rewrite of a query. Such a function is referred to herein as a replacement function. According to an embodiment, a query compiler calls the function to retrieve a replacement query that may be used to replace the table function. The replacement query may be a text string or internal query representation used by a query compiler. An embodiment is not limited to a particular form of a replacement query.

According to an embodiment, database metadata associates a replacement function with a table function. Several ways of associating the replacement function with a table function are described. The present invention is however not limited to any particular way of associating a replacement function with a table function.

Before a user-defined function may be registered, other database objects may have to be defined. For example, if a user-defined function returns a user-defined data type, the date type must first be defined by, for example, submitting DDL statements to a database server.

According to the embodiment, a table function may be implemented using the following steps.

1. An object type of objects of a collection that is returned by the table function is defined by issuing the following DDL statements.

Creat type Person_t as object(ssn numbr, name
varchar2(30));

2. A table type for an object table is defined. This data type is an object collection of the object type Person_t. The table function is defined to return this collection data type.

create type PersonList_t as table of Person_t;

3. An object type that defines a replacement function as an object method of an object type is created. The following DDL statement may be issued to a database server to define such an object type Impl_t and replacement function ODCITableRewrite( ).

```
Create type Impl_t as object
    (...
      static function ODCITableRewrite(sctx OUT imp_t,
    ti IN SYS.ODCITabFuncInfo, sql_str OUT varchar2,
    criteria number) return number
    );
```

ODCITableRewrite( ) returns a replacement query as a text string returned via the argument sql_str. According to an embodiment, the argument list of a replacement function includes the argument list of the table function. In ODCITableRewrite ( ), the table function argument list is after the first three arguments, i.e. the argument criteria number.

4. An implementation for the replacement function ODCITableRewrite ( ) is provided to the database server by issuing the following DDL statement.

```
Create type Ipml_t as object
  static function ODCITableRewrite(sctx OUT imp_t,
  ti IN SYS.ODCITabFuncInfo, sql_str OUT
  varchar2, criteria number) return number
      begin
        if criteria = 1 then
          sql_str := “select ssn, name, from PersonTab2”;
        else
          sql_str := “select ssn, name, from PersonTab2”;
        end if;
        return SYS.ODCIConst.Success;
      end;
    end;
```

The implementation is coded in PL/SQL, a language supported by Oracle™ database servers.

5. The table function is defined and associated with the replacement function by associating the table function with the object type defining the replacement function, using the following DDL statement.

Create function Persons_tf(criteria number) returns
PersonList_t using Impl_t;

The clause using Impl_t identifies to the database server the object type that contains an implementation for the replacement function for the table function Persons_tf.

### Rewriting A Table Function Query

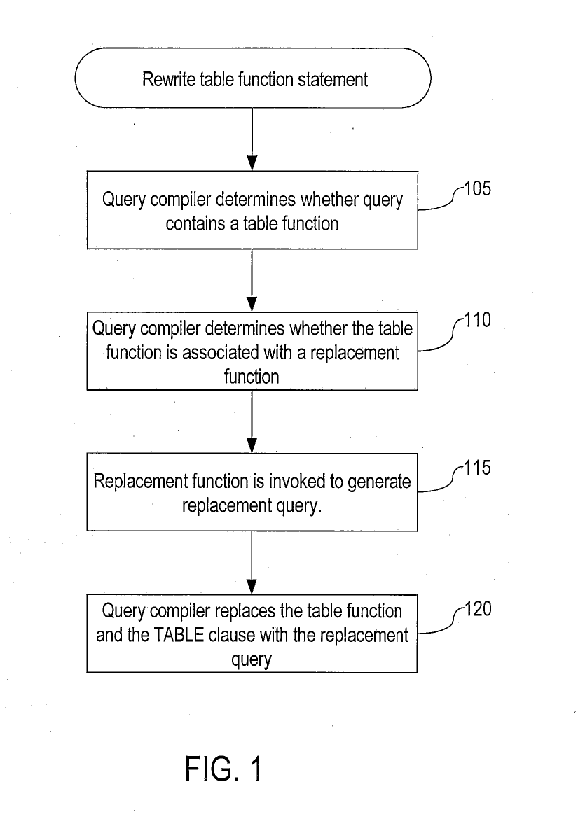

FIG. 1 shows the procedure performed during compile time to rewrite a table function. The procedure may be performed by a database server in response to receiving the table function query. The procedure is illustrated using the following original query QS.

select * from TABLE(Persons_tf(1))

At step 105, a query compiler determines whether query QS contains a table function, which query QS does.

At step 110, in response to determining that query QS contains a table function, the query compiler determines whether the table function is associated with a replacement function. How the determination is made depends on how a replacement function is associated with a table function. In the current illustration, the query compiler determines that an object type associated with the table function Persons_tf (1) has an object method name ODCITableRewrite. This determination is made by examining database metadata defining the function Persons_tf ( ) and the associated object type definition and implementation for Impl_t.

At step 115, in response to determining the replacement function ODCITableRewrite ( ) is associated with the table function, the replacement function is invoked.

At step 120, the query compiler replaces, in effect, the table function and the TABLE clause with the replacement query. In an embodiment, a replacement query may not be returned. In this case, replacing the table function is foregone.

The replacement query returned by the replacement function may not always be the same, even though the implementation of the replacement function does not change. The implementation may have logic to return different replacement queries under different conditions. The value of the replacement query may depend on, for example, the value of an argument of a replacement function. In fact, different replacement queries may be returned at different times for the same argument values.

### Rewrite-Only Functions

In an embodiment, certain table functions may be defined as rewrite-only functions. Any time a rewrite function occurs in a query, the query is rewritten to replace the table function with a replacement query. According to an embodiment, a rewrite-only function is created using a DDL statement that not only specifies to create the function but also specifies an implementation for the body of the function that generates a replacement query. The following DDL statement defines Persons_tf as a rewrite-only function.

```
CREATE FUNCTION Persons_tf(criteria number) return
    varchar2 REWRITE IS sql_str varchar2(1000);
  begin
    if criteria = 1 then
      sql_str := “select ssn, name, from PersonTab1”;
    else
      sql_str := “select ssn, name, from PersonTabs2”;
    end if
  return sql_str
end;
```

In response to receiving the DDL statement, the database generates metadata defining Persons_tf as a rewrite-only table function. The rewrite-only function body implementation in effect serves as the replacement function. When a query compiler compiles a table function query that contains a rewrite-only function, the query determines that the database metadata defines the table function as a rewrite-only function and invokes the implementation defined for the table function.

Finally, in an embodiment it may not be necessary to include a table function in a TABLE clause. The table function may be included in the FROM clause as another source of tuples, similar to a label name for a table or view.

### Hardware Overview

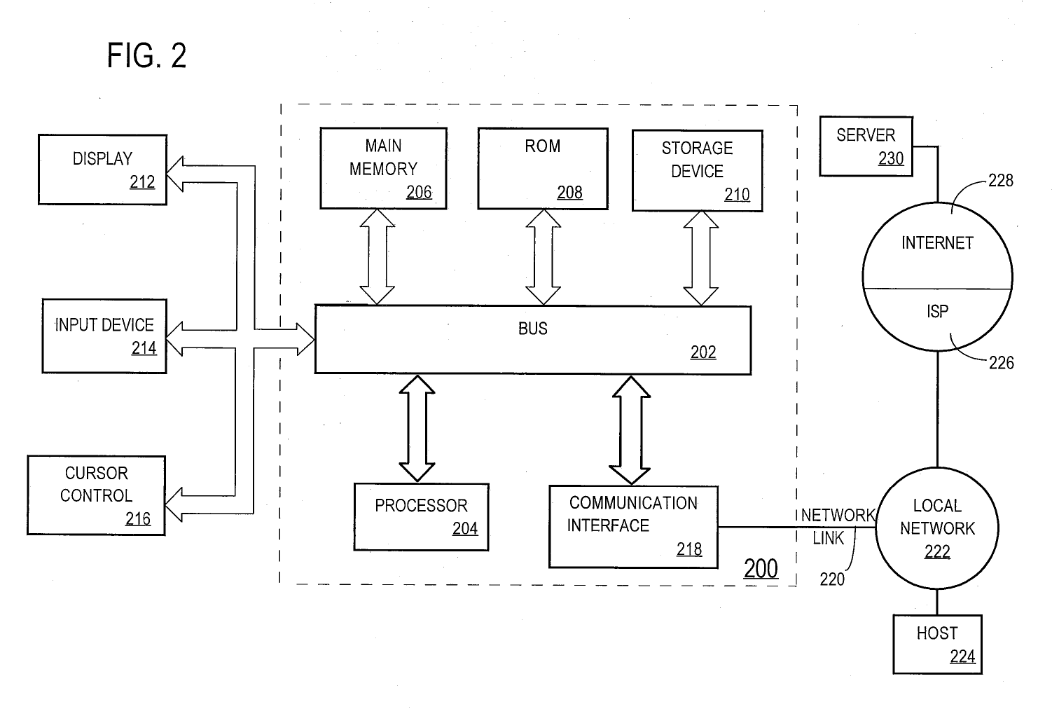

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to storage media and transmission media. Storage media includes both non-volatile media and volatile media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method, comprising:
compiling a database statement that contains a table function, wherein said compiling said database statement includes:
generating a replacement database statement for said table function, and
rewriting said database statement by replacing said table function with said replacement database statement.

2. The computer-implemented method of claim 1, wherein generating a replacement database statement includes calling a replacement function that generates the replacement database statement.

3. The computer-implemented method of claim 2,
wherein the steps further include determining that a replacement function is associated with the said table function; and
wherein calling a replacement function is performed in response to determining that a replacement function is associated with said table function.

4. The computer-implemented method of claim 1,
wherein said table function is contained within a TABLE clause; and
wherein rewriting said database statement includes replacing said TABLE clause.

5. The computer-implemented method of claim 1, wherein said table function is not enclosed within a TABLE clause.

6. A computer-implemented method, comprising:
compiling a first database statement that contains a table function, wherein compiling said first database statement includes:
executing a function to generate a first replacement database statement for said table function, and
rewriting said first database statement by replacing said table function with said replacement database statement;
compiling a second database statement that contains said table function, wherein said compiling said second database statement includes:
executing said function to return a second replacement database statement for said table function, and
rewriting said second database statement by replacing said table function with said second replacement database statement;
wherein the second replacement database statement is different than said first replacement database statement; and
wherein the implementation of said function is the same when the function is executed to generate said first replacement database statement and said second replacement database statement.

7. The computer-implemented method, wherein the steps further include:
a database server receiving a DDL statement that defines said implementation; and
said database server storing metadata that defines said implementation.

8. A computer-implemented method, comprising:
a database server receiving one or more DDL statements that define an function implementation for a certain function to call to generate a replacement database statement for a table function;
in response to receiving said one or more DDL statements, generating metadata that associates said function implementation with said table function;
said database server compiling a database statement that contains said table function, wherein compiling said database statement includes:
based on the metadata, determining to execute said certain function;
executing said certain function to generate a replacement database statement for said table function, and
rewriting said database statement by replacing said table function with said replacement database statement.

9. The computer-implemented method of claim 8, wherein said table function is a rewrite-only function.

10. The computer-implemented method of claim 8, wherein:
said one or more DDL statements define an object method of an object type and an implementation for said object method, wherein said certain function is said object-method; and
said one or more DDL statements associate said object type with said table function.

11. A computer-readable medium carrying one or more sequences of instructions which, when executed by one or more processors, causes the one or more processors to perform the method recited in claim 1.

12. A computer-readable medium carrying one or more sequences of instructions which, when executed by one or more processors, causes the one or more processors to perform the method recited in claim 2.

13. A computer-readable medium carrying one or more sequences of instructions which, when executed by one or more processors, causes the one or more processors to perform the method recited in claim 3.

14. A computer-readable medium carrying one or more sequences of instructions which, when executed by one or more processors, causes the one or more processors to perform the method recited in claim 4.

15. A computer-readable medium carrying one or more sequences of instructions which, when executed by one or more processors, causes the one or more processors to perform the method recited in claim 5.

16. A computer-readable medium carrying one or more sequences of instructions which, when executed by one or more processors, causes the one or more processors to perform the method recited in claim 6.

17. A computer-readable medium carrying one or more sequences of instructions which, when executed by one or more processors, causes the one or more processors to perform the method recited in claim 7.

18. A computer-readable medium carrying one or more sequences of instructions which, when executed by one or more processors, causes the one or more processors to perform the method recited in claim 8.

19. A computer-readable medium carrying one or more sequences of instructions which, when executed by one or more processors, causes the one or more processors to perform the method recited in claim 9.

20. A computer-readable medium carrying one or more sequences of instructions which, when executed by one or more processors, causes the one or more processors to perform the method recited in claim 10.
